(19) United States
(12) Patent Application Publication
(10) Pub. No.: US 2013/0275137 A1
(43) Pub. Date: Oct. 17, 2013

(54) WARNING SYSTEM WITH SYNTHESIZED VOICE DIAGNOSTIC ANNOUNCEMENT CAPABILITY FOR FIELD DEVICES

(71) Applicant: Hamad S. Balhareth, Dhahran (SA)

(72) Inventor: Hamad S. Balhareth, Dhahran (SA)

(73) Assignee: Saudi Arabian Oil Company, Dhahran (SA)

(21) Appl. No.: 13/803,507

(22) Filed: Mar. 14, 2013

Related U.S. Application Data
(60) Provisional application No. 61/624,511, filed on Apr. 16, 2012.

(51) Int. Cl. G10L 13/04

(52) U.S. Cl. CPC G10L 13/043
USPC 704/260

(57) ABSTRACT

Field devices, including sensors and final elements, are provided with a speech synthesizer and optionally a speech control chip, to sound audible voice maintenance and fault alarms to alert field personnel and, optionally, a voice message upon manual activation of a pushbutton or other switch directing them how to perform the maintenance task or clear the fault.

### BACKGROUND OF THE INVENTION

1. Field of the Invention

This invention relates to the integration of audible status reports into field instrumentation and control devices, including sensors and final elements, such as smart emergency shut-off valves and control valves.

2. Description of Related Art

Large industrial facilities such as oil collection plants and refineries, water and wastewater treatment plants, electric utilities and manufacturing plants can include hundreds or thousands of field devices. Field devices include sensors and final elements. Sensors can include pressure, temperature, level and flow measuring sensors and their associated transmitters, position and limit switches, vibration monitors, and other process instruments. Final elements can include electric solenoids, pneumatic actuators and positioners for controlling the starting, stopping and the speed of motors, the opening and closing of valves either fully or to a predetermined position, and heaters and heat exchangers. Field devices are typically connected to a plant-wide central monitoring computer-based system, so that remote field processes can be monitored and controlled from a centralized control location.

In the late 1980s, instrument manufacturers began to embed microprocessors in their field devices which allowed the user to receive diagnostic alarms. However, these diagnostic alarms were only available to operators at the centralized control location. Recent advances in microcomputers and networking have led to advancements in field devices so that they not only permit instrumentation and control to be monitored and directed from a central control location, but they also permit monitoring and control in the field. These advancements providing for control in the field have led to enhanced field monitoring of the health of the field devices themselves. That is, the diagnostic alarms are not only available to operators at the central control location, but also the personnel in the vicinity of the device.

It is known to provide field devices with lights and/or audible alarms that are actuated when a problem with the device has been detected during routine operation or a self-diagnostic check, such as a partial stroke test of valves and valve actuators. See, for example, U.S. Pat. No. 7,504,961, “Emergency Isolation Valve Controller with Integral Fault Indicator” (Flanders, assigned to Saudi Arabian Oil Co.), and U.S. Pat. No. 8,072,343, “Local Emergency Isolation Valve Controller with Diagnostic Testing and Trouble Indicator,” both of which are incorporated by reference. Of course, the purpose of such visible and audible alarms is to attract the attention of personnel in their vicinity. Personnel cannot determine the nature of the problem that caused the alarm to be actuated until they proceed to the local control panel on the device and manually engage the device, e.g., by connecting a portable computer, pad or other smart device to download information, or by pressing a pushbutton type switch to view a display on the device.

As was noted above, a petrochemical or refining facility can contain many thousands of devices that are equipped with these alarm features. It has been found that personnel engaged in other activities in the field who become aware of visible and/or sounding alarms emitted by devices for which they have not then been dispatched to repair or check will not consistently undertake to approach the device to investigate and determine the nature of the problem. If the personnel in the vicinity of the device has not been assigned the task of checking for alarms, there can be a general tendency for such individuals to go about their assigned tasks, based on the assumption that the problem is not significant and/or that others will eventually come to check the device. This lack of knowledge of the reason for the alarm and the associated human response, is a problem that has not been addressed by the prior art.

This is problematic, because a field technician might pass by a field device that is reporting a significant fault without recognizing it, only to learn later from a control room operator of the problem. Likewise, a significant benefit of having control in the field capabilities is to provide for redundancies in the event of a loss in communication between the field and the control room. If this communication is lost, the control room will be unaware of a fault in a field device.

For example, referring to FIG. 1, a prior art embodiment of a warning system 100 for field devices is illustrated. Field devices 110 are located in Tier 3, a CMMS server 120 is located within a control network in Tier 2, and a CMMS client 130 is located within the plant-wide network in Tier 1. Field devices 110 incorporate a microprocessor 112 that provides an instrumentation and control function. For example, if the field device is a sensor, the microprocessor 112 monitors the parameters being monitored by the sensor, for example temperature, pressure, or limit switch status. These monitored parameters are fed to a network 115 which transmits the parameters from field device 110 in Tier 3 to CMMS server 120 in Tier 2, which in turn communicates via network 125 to CMMS client 130 in Tier 1. If the field device is a final element such as a valve controller, the microprocessor 112 provides a control function, such as receiving a signal to close the associated valve. This signal is typically initiated at CMMS client 130 in Tier 1, is transmitted to CMMS server 120 in Tier 2, and then is transmitted to the microprocessor 112 in field device 110 in Tier 3.

In addition to microprocessor 112 performing these instrumentation and control functions, microprocessor 112 monitors the health of the field device. If field device 110 requires maintenance or repair, microprocessor 112 communicates this information upstream to CMMS client 130, via network 115, CMMS server 120, and network 125. An operator 140 assigned to monitor CMMS client 130 receives the message that field device 110 requires maintenance or repair. The maintenance or repair function is conducted by field personnel 150. Operator 140 communicates the maintenance or repair message to field personnel 150 via communications path 145. Depending upon the distance between operator 140 and field personnel 150, and the availability of cellular telephone coverage or radio coverage, this message could be delayed. Similarly, in the event of a malfunction of CMMS server 120, CMMS client 130, or networks 115 or 125, the maintenance or repair message from microprocessor 112 of field device 110 might be delayed or even prevented from reaching operator 140, and thus would not be relayed to field personnel 150. These shortcomings are representative of a problem with the prior art systems.

It is therefore an object of the present invention to provide a solution whereby field devices can provide audible status reports so that field personnel working in the vicinity can recognize that a field device requires maintenance or repair. Another object of the present invention is that the status reports can guide the field personnel in maintaining or repairing the field device.

### SUMMARY OF THE INVENTION

The above objects and further advantages are provided by the invention that integrates audible aural or spoken messages in the form of status warnings device alerts (i.e., status reports) into field devices.

In accordance with one aspect of the present invention, a field device includes a system that integrates a microprocessor with indicating lights, a speaker, one or more pushbuttons, and associated control circuitry in order to provide field personnel in the vicinity of the device with both an audio and visual indication of the health of such devices. A voice synthesizer and/or memory device with pre-recorded messages corresponding to predetermined faults or defects for which the device is tested is provided.

For example, in one embodiment, an operator field service or maintenance personnel sees an illuminated indicator light on the field device, signaling that the device has a message for personnel. The field device could have a number of indicator lights of different colors, for example traditional low-voltage incandescent bulbs with colored caps, a single indicator light with illumination provided by one of a number of LEDs. For example, a green light would indicate that an advisory-type of message is available, a yellow light would indicate that a maintenance alarm is present, and a red light would indicate that there is a serious problem requiring immediate attention. Upon approaching the device, the operator presses a pushbutton to receive an aural message. For example, the operator presses a first pushbutton and the device announces, “Air supply low.” In an alternative embodiment, there is a second pushbutton to provide additional guidance, for example, “Check air supply and increase to 40 PSI.”

In a further embodiment, the field device repeatedly announces aural maintenance alarms or serious problems at regular intervals, without requiring an operator to first press a pushbutton. This embodiment functions to draw the attention of a passing field employee who had not noticed that the indicator light is illuminated.

In one embodiment, the audible announcements can be a human voice that is recorded, for example, as a WAV file stored in the memory of the final device's microprocessor. In another embodiment, the audible announcements can be generated by a digital text-to-speech synthesizer.

### BRIEF DESCRIPTION OF THE DRAWINGS

The invention will be described in further detail below and with reference to the attached drawings in which the same or similar elements are referred to by the same numerals, and where:

FIG. 1 is a block diagram of a prior art warning system for field devices;

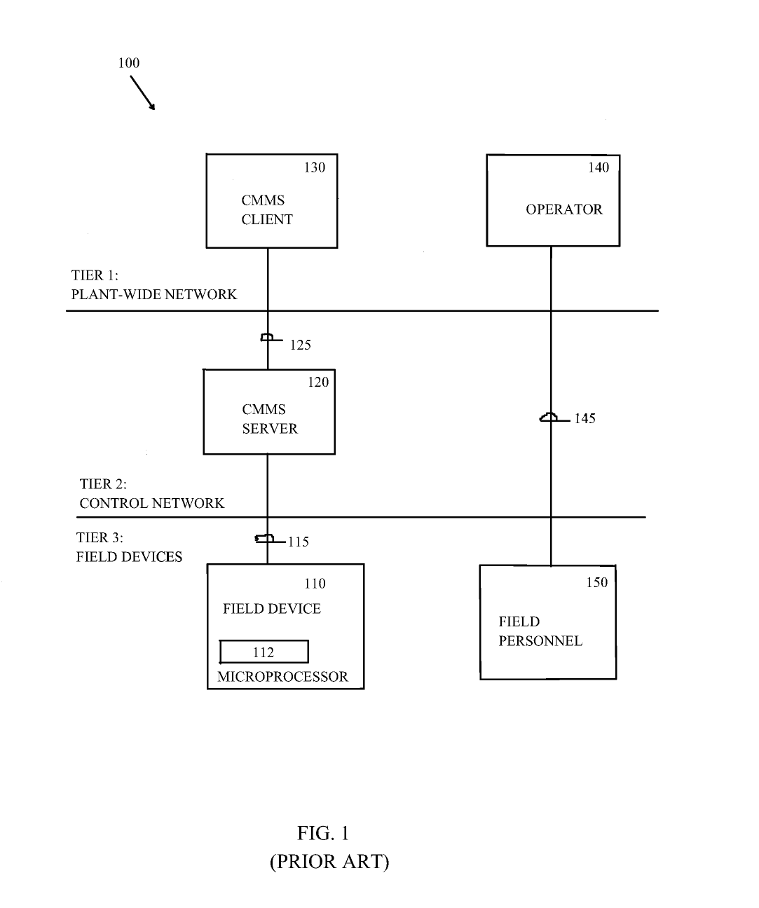

FIG. 2 is a block diagram of a warning system for field devices in accordance with an embodiment of the present invention; and

FIG. 3 is a block diagram of several components of a field device incorporating an embodiment of the present invention.

### DETAILED DESCRIPTION OF THE INVENTION

The present invention broadly comprehends an enhanced warning system for field devices that incorporates means for issuing aural status reports to enable field devices, empowering field personnel to respond more quickly to maintenance and repair messages.

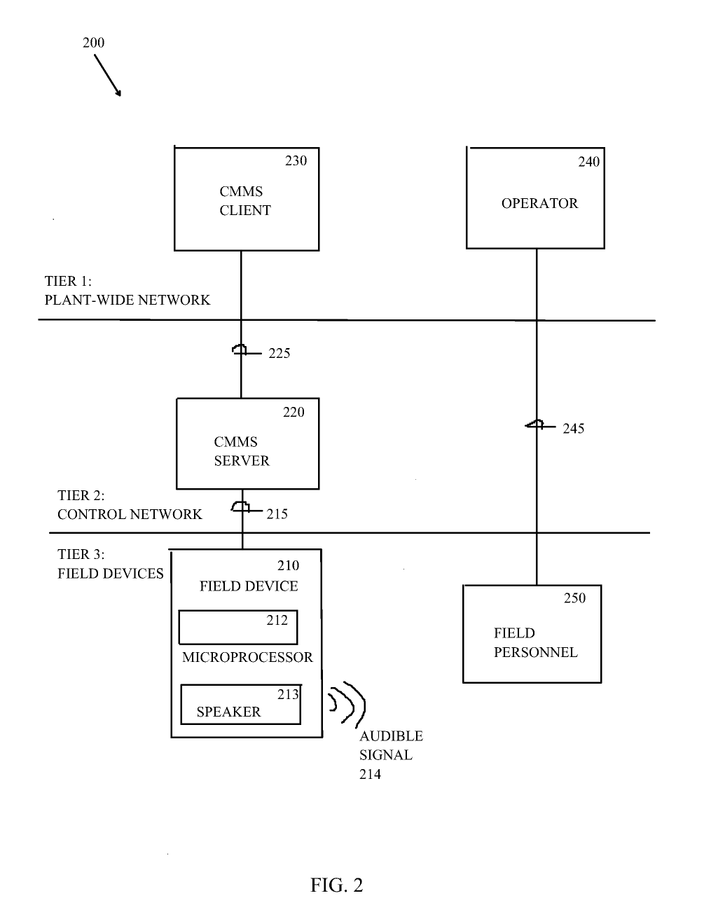

Referring to FIG. 2, an embodiment of the present invention, a warning system 200 for field devices that produces audible aural status reports is illustrated. Field devices 210 are located in Tier 3, a CMMS server 220 is located within a control network in Tier 2, and a CMMS client 230 is located within the plant-wide network in Tier 1. Field devices 210 incorporate a microprocessor 212 that provides an instrumentation and control function. Monitored parameters are fed to a network 215 which transmit the parameters from field device 210 in Tier 3 to CMMS server 220 in Tier 2, which in turn communicates via network 225 to CMMS client 230 in Tier 1. If the field device is a final element, such as a valve controller, the microprocessor 212 provides a control function, such as receiving a signal to close the associated valve. This signal is typically initiated at CMMS client 230 in Tier 1, is transmitted to CMMS server 220 in Tier 2, and then transmitted to microprocessor 212 in field device 210 in Tier 3.

In addition to microprocessor 212 performing these instrumentation and control functions, microprocessor 212 monitors the health of the field device. If field device 210 requires maintenance or repair, microprocessor 212 communicates this information in two ways. Firstly, as with the prior art, microprocessor 212 communicates the maintenance or repair message upstream to CMMS client 230, via network 215, CMMS server 220, and network 225, where it must come first to the attention of operator 240 before any action is taken. Secondly, field devices 210 are provided with a speaker and control circuitry 213 through which microprocessor 212 outputs a signal, which in turn produces an audible signal 214 intended to draw the attention of any field personnel 250 in the area. Ordinarily, the prior art practice of operator 240 communicating the maintenance or repair method to field personnel 250 via communications path 245 will also be available. Thus, the invention allows field personnel 250 to learn of a maintenance or repair message directly and immediately from field device 210, if the field personnel 250 are in the vicinity. The invention also allows them to check the status of field device 210 in the field in the event of a malfunction of CMMS server 220, CMMS client 230, or networks 215 or 225. If field personnel 250 are not in the vicinity of field device 210 and there is no malfunction of CMMS server 220, CMMS client 230, or networks 215 or 225, then operator 240 can communicate the maintenance or repair message to field personnel 250, as in the prior art.

As can be seen, the addition of audible signal capabilities to the field devices provides a redundant path for alerting field personnel of maintenance or repair actions that are required.

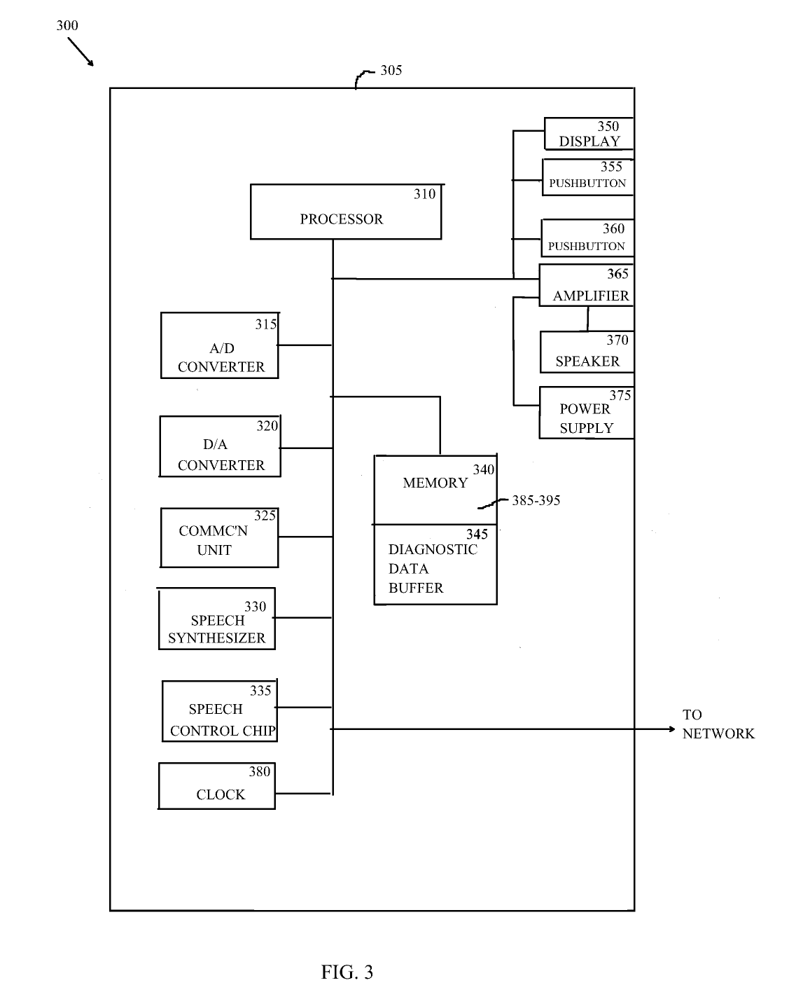

FIG. 3 illustrates a block diagram of several components of a typical field device incorporating an embodiment of the present invention. Field device 300 includes an enclosure 305, processor 310, sensors (not shown), a memory 340, an analog-to-digital (A/D) converter 315 and a digital-to-analog (D/A) converter 320. Memory 340 and diagnostic data buffer 345 are utilized to store a variety of information. A/D converter 315 converts the inputs from one or more sensors from analog to digital format and transfers the corresponding digital signals to processor 310. D/A converter 320 can convert a plurality of outputs from the control network to the field device and is especially useful for final elements. For example, if field device 300 is a digital valve controller, D/A converter 320 can convert a digital command received from the control network to an analog signal that drives a valve actuator to close predetermined percentages, e.g., 50%, or until a predetermined desired flow rate or pressure is achieved.

Field device 300 further includes clock 380 and communication unit 325. Data can be transferred over the control network, or alternatively can be transferred with a portable communications device through communication unit 325.

Speech synthesizer 330 is a voice and sound synthesizer. Inexpensive speech synthesizers are commercially available and their use in the present invention is within the skill in the art. The Magnevation SpeakJet is preprogrammed with 72 speech elements (allophones). Software to program a speech synthesizer in plain-text as opposed to allophones can be incorporated into processor 310, or alternatively the function can be provided as a separate speech control chip 335. Speech control chips are also commercially available. The Magnevation TTS256, which has a built-in 600 rule database to convert English text to allophones can be incorporated in the field devices and actuated by the microprocessor.

Speaker 370 and amplifier 365 provide speech and/or sound to draw the attention of field personnel, and to provide directions to field personnel to identify the problem and its resolution. Power supply 375 provides power to amplifier 365.

In an alternate embodiment, speaker 370 and amplifier 365 only provide speech and/or sound to draw the attention of field personnel if a motion sensor (not shown) detects field personnel and/or vehicles in a predetermined range of proximity to the device.

In addition to the audible alarm, the field device can also be provided with visible alarms, such as indicator lights of different colors (not shown). For example, a green light can indicate that an advisory-type of message is available, a yellow light that a maintenance alarm is present, and a red light that there is a serious problem requiring immediate attention.

Display 350 is typically an LCD screen that can, for example, in the case of a field device that is a sensor, provide a digital readout of pressure, temperature, or other parameter. Display 350 can also be used to provide control instructions, and to provide maintenance and repair messages to field personnel.

In one embodiment of the invention, there are two pushbuttons, 355 and 360. In the event of a malfunction, an alarm routine 385 stored in memory 340 adapted to be executed in processor 310 calls for an audible signal to be sounded by speech synthesizer 330, amplifier 365 and speaker 370. This can be a continuous or variable tone, or a recorded sound or voice such as from a WAV file. In an alternative embodiment, alarm routine 385 calls for text to be sent to speech control chip 335, which converts the text into allophones to be processed by speech synthesizer 330 and passed through amplifier 365 and speaker 370. In yet another alternative embodiment, alarm routine 385 calls for text to be sounded, with alarm routine 385 including a subroutine (or by activating a separate routine) that converts the text into allophones, the allophones being sent directly to speech synthesizer 330, thereby obviating the need for speech control chip 335.

Field personnel hearing a sounded alarm approach field device 300 and press the first pushbutton 355, upon which a status routine 390 stored in memory 340 adapted to be executed in processor 310 calls for a spoken status (e.g., “air supply low”) to be sounded by speech synthesizer 330, amplifier 365 and speaker 370. Status routine 390 can include a subroutine (or activate a separate routine) that converts the desired text into allophones to be sent to speech synthesizer 330, or alternatively status routine 390 can send text to a separate speech control chip 335, which then sends allophones to speech synthesizer 330.

The field personnel then presses the second pushbutton 360, upon which an instructional routine 395 stored in memory 340 adapted to be executed in processor 310 calls for a spoken instruction, e.g. “check air supply and increase to 40 PSI”, to be sounded by speech synthesizer 330, amplifier 365 and speaker 370. Instructional routine 395 can include a subroutine (or activate a separate routine) that converts the desired text into allophones that are sent to speech synthesizer 330, or alternatively instructional routine 395 sends a text to a separate speech control chip 335, which then sends allophones to speech synthesizer 330. Thus, the invention not only serves the purpose of informing field personnel of maintenance or failures, but also serves to educate them in performing the maintenance or clearing the fault. One of ordinary skill in the art would recognize that in lieu of two pushbuttons, a single pushbutton would suffice, for example by being pressed twice in succession.

The present invention has been described above and with reference to the attached drawings; however, modifications will be apparent to those of ordinary skill in the art and the scope of protection for the invention is to be defined by the claims that follow.

I claim:

1. An instrumentation and control field device comprising:
a processor;
a memory coupled to the processor;
a speech synthesizer to produce sounds, including allophones;
a speaker;
an amplifier;
at least one pushbutton;
an alarm routine stored in the memory and adapted to be executed by the processor upon a device alert, causing an audible alarm to be sounded by the amplifier and speaker to attract the attention of personnel in the vicinity of the field device;
a status routine stored in the memory and adapted to be executed in the processor upon manual actuation of a switch that causes a text status to be received by the speech synthesizer, the speech synthesizer converting the text status to a spoken status and forwarding the spoken status to be sounded by the amplifier and speaker; and
an optional instructional routine stored in the memory and adapted to be executed in the processor following enunciation of the text status by the speech synthesizer and transmitting a text instruction to the speech synthesizer which converts the text instruction to a spoken instruction and forwards the spoken instruction to be sounded by the amplifier and speaker.

2. The instrumentation and control field device of claim 1 in which the instruction is transmitted upon the manual actuation of a switch.

3. The instrumentation and control field device of claim 1, wherein the audible alarm is a prerecorded sound file.

4. The instrumentation and control field device of claim 2, wherein the audible alarm is selected from a plurality of sounds and the sound is selected based upon the nature of the device alert.

5. The instrumentation and control field device of claim 1, wherein the audible alarm is a text alarm that is transmitted to the speech synthesizer for conversion of the text alarm to a spoken alarm.

6. The instrumentation and control field device of claim 5 which includes a motion sensor responsive to personnel and/or vehicles in a predetermined range of proximity to the device.

7. The instrumentation and control field device of claim 5, further comprising a speech control chip, wherein the text status and text instruction received by the speech synthesizer are first processed by the speech control chip, which instructs the speech synthesizer to sound selected allophones through the amplifier and speaker.

8. The instrumentation and control field device of claim 5, further comprising a speech control chip which first processes the text alarm, text status and text instruction that are transmitted by the speech synthesizer, and which instructs the speech synthesizer to sound selected allophones through the amplifier and speaker.

9. The instrumentation and control field device of claim 1, further comprising a speech control routine stored in the memory and adapted to be executed in the processor, wherein the speech control routine instructs the speech synthesizer to sound selected allophones through the amplifier and speaker.

10. The instrumentation and control field device of claim 5, further comprising a speech control routine stored in the memory and adapted to be executed in the processor, wherein the speech control routine processes the text alarm, text status and text instruction transmitted to the speech synthesizer and instructs the speech synthesizer to sound selected allophones through the amplifier and speaker.
